(19) United States
(12) Patent Application Publication
(10) Pub. No.: US 2021/0046496 A1
(43) Pub. Date: Feb. 18, 2021

(54) WATERPROOF-TYPE PUMP DISPENSER

(71) Applicant: APOLLO INDUSTRIAL CO., LTD., Siheung-si, Gyeonggi-do (KR)

(72) Inventor: Jae Kyung LEE, Seoul (KR)

(21) Appl. No.: 16/323,877

(22) PCT Filed: Sep. 11, 2017
(86) PCT No.: PCT/KR2017/009949

§ 371 Date: Feb. 7, 2019

(30) Foreign Application Priority Data
Jul. 18, 2017 (KR) 10-2017-0091110

(51) Int. Cl. B05B 11/00

(52) U.S. Cl. CPC B05B 11/3047; B05B 11/3002; B05B 11/3059; B05B 11/3067; B05B 11/3074

(57) ABSTRACT

Provided is a waterproof-type pump dispenser which is configured to more securely maintain a locked state of a push head and a piston shaft and to prevent foreign substances such as water from being introduced into a cylinder from the outside by improving a locking structure.

### TECHNICAL FIELD

The present invention relates to a pump dispenser, and more particularly to a waterproof-type pump dispenser that is mounted to a container containing liquid contents and that is capable of suctioning/pumping the liquid contents to discharge the same outside through repeated pressing of a push head.

### BACKGROUND ART

In general, a container, which stores liquid contents, such as cosmetics, in the form of liquid or paste, shampoo, rinse, or the like, is equipped with a pump dispenser, which discharges the contents in a predetermined amount using air pressure.

A conventional pump dispenser, as illustrated in FIG. 1, includes a pumping unit 20, which is coupled to the neck of a container 10 and has therein a pressure chamber 22a to temporarily store liquid contents by suctioning/pumping the same, and a push head 30, which has therein a discharge passage 31 to discharge the pumped liquid contents outside by applying pressure to the pressure chamber 22a in the pumping unit 20.

The pumping unit 20 includes a cap 21, which is mounted on the neck of the container 10 in a thread-coupling manner, a cylinder 22, which is centrally disposed in the cap 21 and has therein a pressure chamber 22a, a ball valve 24, which is provided in a suction port 23 formed in the lower end of the cylinder 22, a coil spring 25, which is mounted in the pressure chamber 22a in the cylinder 22, a hollow piston shaft 26, which has a lower end portion received in the cylinder 22 so as to be movable upwards or downwards and which is elastically supported by the coil spring 25, a piston 27, which is provided so as to surround the lower end portion of the piston shaft 26 and which has a periphery closely contacting the inner wall of the cylinder 22, and a locking member 28, which is fixedly coupled to the upper end of the cylinder 22, which penetrates the top surface of the cap 21 and extends upwards, and which has a female thread 28a formed in the inner wall thereof. The push head 30 is coupled to the upper end of the piston shaft 26 in a fitting manner, and has a male thread 32 formed at the lower portion thereof so as to mesh with the female thread 28a of the locking member 28 to maintain a locked state.

In the conventional pump dispenser configured as described above, if the push head 30 is pushed with the hand, the piston shaft 26 overcomes the elastic force of the coil spring 25 and moves downwards, whereby the liquid contents occupying the pressure chamber 22a in the cylinder 22 move into the internal space in the piston shaft 26, and are subsequently discharged outside through the discharge passage 31 in the push head 30. At this time, the ball valve 24 is brought into contact with the suction port 23 by the downward pressure of the contents in the cylinder 22 and interrupts communication between the pressure chamber 22a and the interior of the container 10. If, however, the hand is taken off the push head 30, the piston shaft 26 moves upwards due to the elastic support force of the coil spring 25, the discharge of the contents is interrupted, and a vacuum is formed in the pressure chamber 22a in the cylinder 22. Thus, a portion of the liquid contents stored in the container 10 causes the ball valve 24 to move upwards and is suctioned and fills the pressure chamber 22a again. At this time, external air is introduced into the container 10 through an air hole 29, which is formed in the wall of the cylinder 22, and fills the space from which the contents have been drawn out. The liquid contents in the container 10 are discharged in a predetermined amount through the operation of repeatedly pushing the push head 30.

A product equipped with this conventional pump dispenser is distributed in the market in the initial state, in which the push head 30 is locked to the female thread 28a of the locking member 28, and can be used by unlocking the push head 30. Thus, in the case in which a product equipped with the conventional pump dispenser is used in a bathroom or the like, water (foreign substances) may be introduced into the upper portion of the cylinder 22 through a gap between the locking member 28 and the piston shaft 26, and may be subsequently introduced into the container 10 through the air hole 29, which may cause deterioration of the contents. This phenomenon occurs because the locking member 28 for locking the push head 30 during product distribution in the market is exposed outside the cap 20, and thus a gap, through which foreign substances may be introduced, is created.

### DISCLOSURE

### Technical Problem

The present invention has been made in view of the above problems, and it is an object of the present invention to provide a waterproof-type pump dispenser that has an improved locking structure of a push head and a piston shaft, thereby more securely maintaining a locked state and preventing foreign substances (water) from being introduced from the outside into the upper space in a cylinder.

In addition, it is another object of the present invention to provide a waterproof-type pump dispenser that ensures more accurate ascending/descending operation of a push head while preventing the introduction of external foreign substances.

### Technical Solution

In accordance with the present invention, the above objects can be accomplished by the provision of:

a waterproof-type pump dispenser mounted to a neck of a container and configured to suction and pump liquid contents to discharge the same outside,

the waterproof-type pump dispenser including: a cap mounted to the neck of the container in a thread-coupling manner, the cap having a cylindrical-shaped first waterproof wall protruding from the center of the top surface thereof; a cylinder centrally mounted in the cap, the cylinder being formed in the shape of a hopper having a pressure chamber formed therein to suction and temporarily store the contents and a suction port formed in a lower portion thereof and configured to be connected with a suction tube in a fitting manner; a check valve mounted in the suction port in the cylinder to open or close the suction port; a hollow piston shaft having a lower end portion located in the cylinder so as to be movable upwards or downwards, an upper end portion penetrating the first waterproof wall and extending upwards, a discharge passage formed therein in the longitudinal direction thereof, and locking protrusions protruding from the outer wall of the upper end portion thereof; a piston coupled to the lower end portion of the hollow piston shaft 240 in a fitting manner so as to ascend or descend together therewith, the piston being configured to open or close a communication hole formed in the lower end portion of the hollow piston shaft, and having a periphery closely contacting the inner wall of the cylinder; a cylindrical-shaped locking bushing having a lower end portion coupled to an open upper portion of the cylinder in a fitting manner, an upper end portion accommodated in the first waterproof wall of the cap, guide grooves formed in the inner wall of the upper end portion thereof in the longitudinal direction thereof, the guide grooves being arranged opposite each other to receive the locking protrusions therein and to guide ascending/descending movement of the hollow piston shaft, and twist-locking grooves extending from the lower ends of the guide grooves in a circumferential direction so that, when the hollow piston shaft is pushed down to the maximum extent and is subsequently rotated at a predetermined angle, the locking protrusions are caught in the twist-locking grooves and the hollow piston shaft gets locked; a coil spring having a lower end caught and supported by the lower end portion of the locking bushing and an upper end supported by the upper end portion of the hollow piston shaft, the coil spring being configured to elastically support the hollow piston shaft in an upward direction; and a push head mounted on the upper end portion of the hollow piston shaft so as to ascend or descend together therewith, the push head having a dispensing port formed in an upper portion thereof so as to communicate with the discharge passage in the hollow piston shaft and a cylindrical-shaped second waterproof wall formed at a lower portion thereof so as to surround the outer periphery of the first waterproof wall of the cap.

In addition, according to the present invention, the locking bushing has a cylindrical-shaped moving guide integrally formed with the inner wall of the lower end portion thereof, the lower end of the coil spring is caught and supported by the moving guide, and the moving guide has an inner surface contacting the outer wall of the hollow piston shaft to guide the ascending/descending movement of the hollow piston shaft.

### Advantageous Effects

According to the waterproof-type pump dispenser of the present invention configured as described above, since the outer periphery of the first waterproof wall of the cap is shielded by the second waterproof wall of the push head at all times, it is possible to prevent foreign substances (water or the like) from being introduced into the cylinder from the outside. Further, when the push head is repeatedly pushed down, the push head ascends or descends in the state in which the second waterproof wall surrounds the first waterproof wall, and thus the ascending/descending movement thereof is more accurately realized. Still further, since the hollow piston shaft smoothly and accurately ascends or descends along the guide grooves and the moving guide of the locking bushing, it is possible to operate the push head with less pressing force.

In addition, according to the waterproof-type pump dispenser of the present invention, since the hollow piston shaft is locked in the locking grooves by pushing down the hollow piston shaft to the maximum extent and rotating the same at a predetermined angle (in the locking direction) via the push head, a phenomenon in which the contents stored in the container leak (a liquid leakage phenomenon) is prevented while the product is distributed in the market or is carried, thereby further improving the reliability of the product. In particular, since the locking bushing is mounted inside the cap, the pump dispenser is provided with a locking function without marring the aesthetic appearance of the product.

### DESCRIPTION OF DRAWINGS

FIG. 1 is a view illustrating a conventional pump dispenser.

FIG. 2 is a cross-sectional view illustrating the state in which a waterproof-type pump dispenser according to the present invention is assembled with a container.

FIG. 3 is a cross-sectional view illustrating the internal structure of the waterproof-type pump dispenser according to the present invention.

FIG. 4 is an exploded cross-sectional view illustrating a hollow piston shaft, a locking bushing and a piston of the waterproof-type pump dispenser according to the present invention.

FIG. 5 is a perspective view illustrating the locking bushing of the waterproof-type pump dispenser according to the present invention.

FIGS. 6 and 7 are views sequentially illustrating the pumping operation of the waterproof-type pump dispenser according to the present invention.

FIGS. 8 to 10 are views sequentially illustrating the process of locking the waterproof-type pump dispenser according to the present invention.

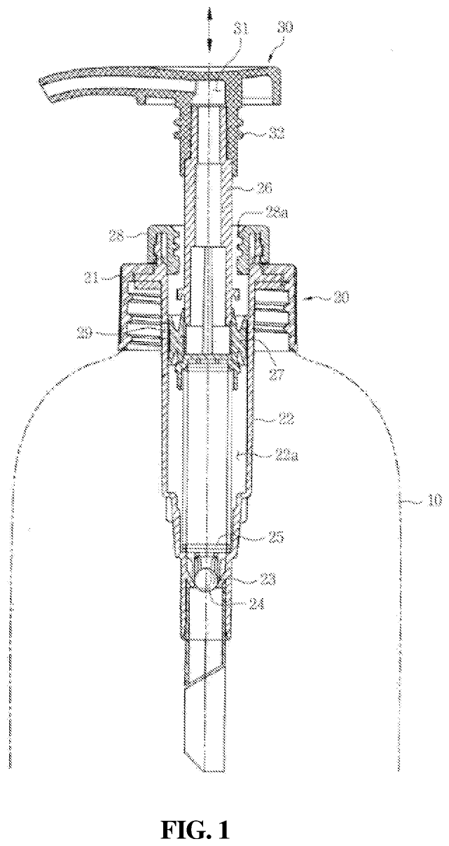

### DESCRIPTION OF REFERENCE NUMERALS

100 . . . container 110 . . . neck A . . . liquid contents
200 . . . pump dispenser 210 . . . cap 211 . . . female thread
212 . . . first waterproof wall 220 . . . cylinder 221 . . . pressure chamber
222 . . . suction port 223 . . . suction tube 224 . . . air hole
230 . . . check valve 240 . . . hollow piston shaft 241 . . . discharge passage
242 . . . communication hole 243 . . . outward flange 244 . . . locking protrusion
250 . . . piston 251 . . . lip 260 . . . locking bushing
261 . . . guide groove 262 . . . twist-locking groove 263 . . . locking bump
264 . . . moving guide 270 . . . coil spring 280 . . . push head
281 . . . dispesning port 282 . . . second waterproof wall

### BEST MODE

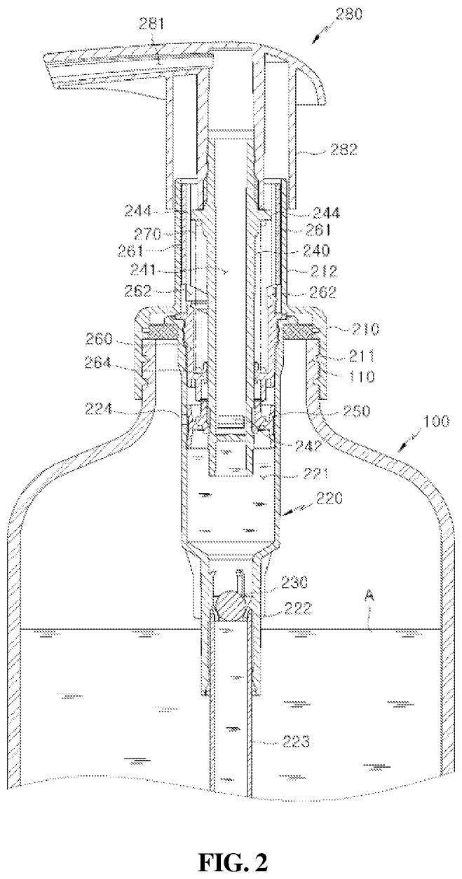

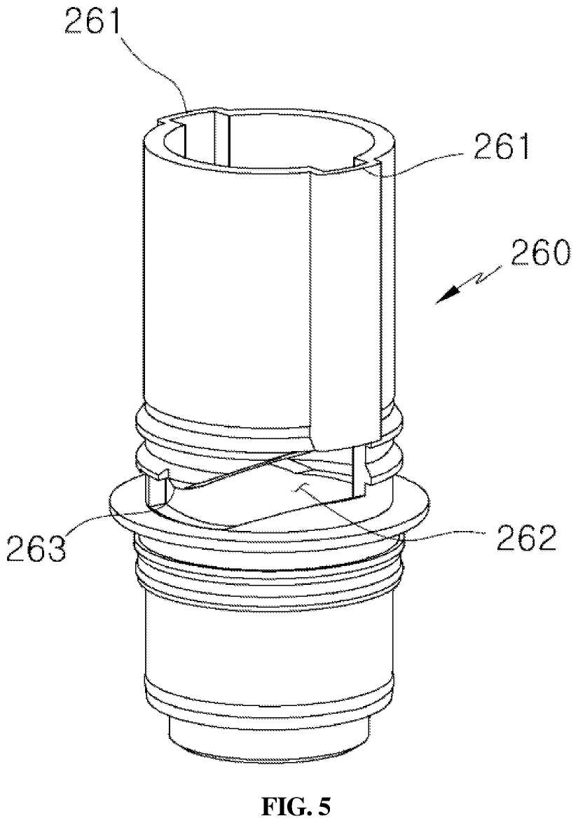

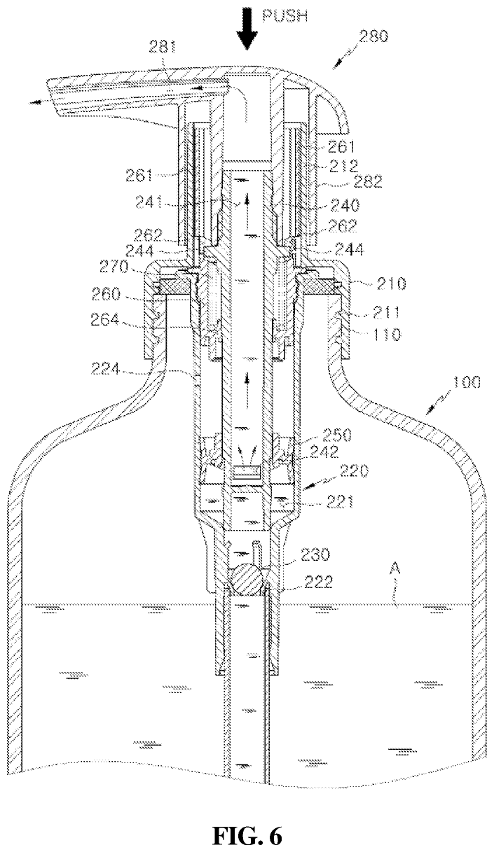

Hereinafter, an exemplary embodiment according to the present invention will be described in detail with reference to the accompanying drawings. Describing the accompanying drawings in brief, FIGS. 2 to 5 are views illustrating the configuration of a waterproof-type pump dispenser according to the present invention, and FIGS. 6 to 10 are views illustrating the operation of the waterproof-type pump dispenser according to the present invention.

<Description of Configuration of Waterproof-Type Pump Dispenser According to Present Invention>

As illustrated in FIG. 2, a waterproof-type pump dispenser 200 according to the present invention is assembled with a neck 110 of a container 100 and suctions/pumps liquid contents A stored therein to discharge the liquid contents outside in a predetermined amount. The waterproof-type pump dispenser includes a cap 210, which is assembled with the neck 110 of the container 100 in a thread-coupling manner, a cylinder 220, which is mounted in the cap 210 and which is formed in the shape of a hopper having a suction port 222 formed in the lower portion thereof, a check valve 230, which is configured to selectively open or close the suction port 222 in the cylinder 220, a hollow piston shaft 240, which is provided in the cylinder 220 so as to be movable upwards or downwards and which has a discharge passage 241 formed therein, a piston 250, which is coupled to the lower end portion of the hollow piston shaft 240 in a fitting manner so as to ascend or descend together therewith, a locking bushing 260, which is coupled to the upper portion of the cylinder 220 to guide the ascending/descending movement of the hollow piston shaft 240 and to lock the same, a coil spring 270, which elastically supports the hollow piston shaft 240 in the upward direction, and a push head 280, which is mounted on the upper end portion of the hollow piston shaft 240 and which has a content-dispensing port 281 formed therein. The constituent elements of the waterproof-type pump dispenser according to the present invention other than the coil spring 270 may be formed from synthetic resin, and the detailed configurations thereof will be described below.

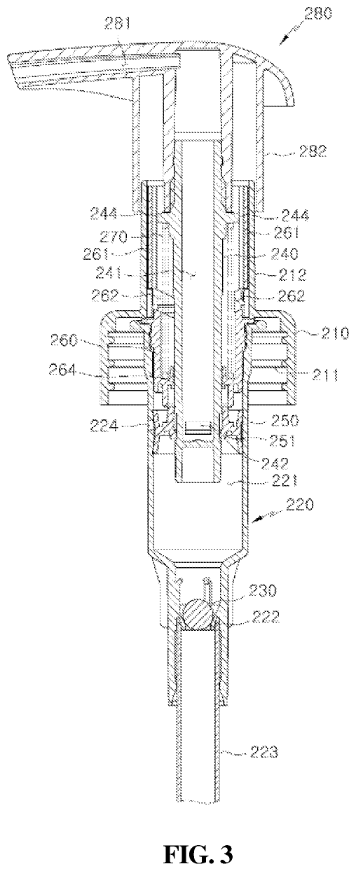

Referring to FIGS. 2 and 3, the cap 210 is mounted to the neck 110 of the container 100, in which liquid contents A are stored, in a thread-coupling manner. To this end, a female thread 211 is formed in the inner wall of the cap 210. In addition, a cylindrical-shaped first waterproof wall 212, which is hollow in the vertical direction, is formed on the center of the top surface of the cap 210 so as to protrude upwards. The first waterproof wall 212 serves to prevent the introduction of foreign substances from the outside and to accommodate the locking bushing 260.

Referring to FIG. 3, the cylinder 220 is centrally mounted in the cap 210. The cylinder 220 has an air hole 224 formed in the wall of the upper end portion thereof, and is formed in the shape of a hopper having a pressure chamber 221 formed therein to suction the liquid contents and temporarily store the same. The air hole 224 serves to allow external air to be introduced therethrough and fill the space in the container 100 from which the liquid contents A have been drawn out, thereby ensuring smooth discharge of the contents A. In addition, the cylinder 220 has a suction port 222 formed in the lower portion thereof, into which a suction tube 223 is fitted to suction the contents A.

The check valve 230 serves to selectively open or close the suction port 222 in the cylinder 220. In the embodiment of the present invention, the check valve 230 is configured as a steel ball, and opens or closes the suction port 222 in response to the ascending/descending movement of the hollow piston shaft 240 and the piston 250.

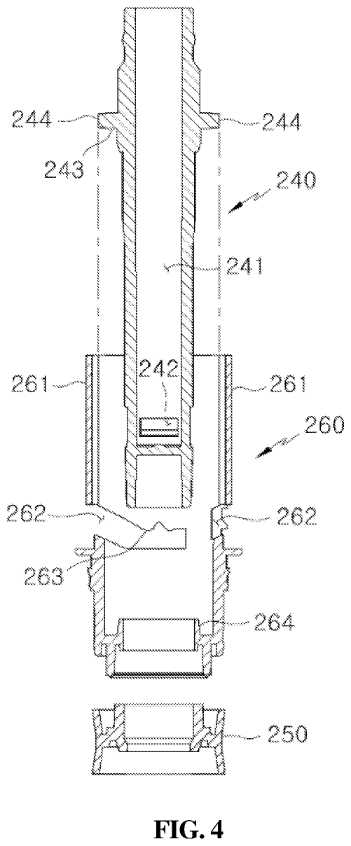

Referring to FIGS. 3 and 4, the lower end portion of the hollow piston shaft 240 is located in the cylinder 220 so as to be movable upwards or downwards, and the upper end portion thereof penetrates the first waterproof wall 212 and extends upwards. The hollow piston shaft 240 has a discharge passage 241 formed therein in the longitudinal direction thereof and locking protrusions 244 protruding from the outer wall of the upper end portion thereof. In the embodiment of the present invention, the locking protrusions 244 are arranged opposite each other at 180 degrees. In addition, the hollow piston shaft 240 has a communication hole 242 formed in the wall of the lower end portion thereof, through which the discharge passage 241 and the pressure chamber 221 communicate with each other.

The piston 250 is coupled to the lower end portion of the hollow piston shaft 240 in a fitting manner. The piston 250 ascends or descends together with the hollow piston shaft 240 in the state in which the periphery thereof closely contacts the inner wall of the cylinder 220, and opens or closes the communication hole 242 in the hollow piston shaft 240. That is, an inner lip 251 of the piston 250 selectively opens or closes the communication hole 242 in response to the internal pressure in the pressure chamber 221.

Referring to FIGS. 3 to 5, the locking bushing 260 is formed in the shape of a cylinder that is hollow in the vertical direction. The lower end portion of the locking bushing 260 is coupled to the open upper portion of the cylinder 220 in an interference-fitting manner, and the upper end portion thereof is accommodated in the first waterproof wall 212 of the cap 210. The locking bushing 260 has guide grooves 261 formed in the inner wall of the upper end portion thereof in the longitudinal direction thereof. The guide grooves 261 are arranged opposite each other at 180 degrees in order to receive the locking protrusions 244 therein and consequently to guide the ascending/descending movement of the hollow piston shaft 240. Twist-locking grooves 262 are formed in the lower ends of the guide grooves 261 so as to extend at a predetermined angle in a circumferential direction. If the hollow piston shaft 240 is pushed down to the maximum extent and is subsequently rotated at a predetermined angle along the twist-locking grooves 262, the locking protrusions 244 are caught in the twist-locking grooves 262, whereby the hollow piston shaft 240 is maintained in a locked state. In the embodiment of the present invention, the twist-locking grooves 262 are also arranged opposite each other at 180 degrees in the lower ends of the corresponding guide grooves 261. The twist-locking grooves 261 have locking bumps 263 formed in the middle thereof. Thus, in order to lock the hollow piston shaft 240 or to release the same from the locked state, it is required to push down the hollow piston shaft 240 to the maximum extent and rotate the same by applying physical force to the same. In addition, the lower end of the coil spring 270 is caught and supported by the inner wall of the lower end portion of the locking bushing 260. The locking bushing 260 has a cylindrical-shaped moving guide 264 integrally formed with the inner wall of the lower end portion thereof. The inner surface of the moving guide 264 is in contact with the outer wall of the hollow piston shaft 240 in order to guide the ascending/descending movement of the hollow piston shaft 240.

Referring to FIG. 3, the coil spring 270 serves to elastically support the hollow piston shaft 240 and the piston 250 in the upward direction in order to move the same upwards or downwards, and is mounted so as to surround the outer circumference of the hollow piston shaft 240, which is exposed upwards from the cylinder 220. That is, the lower end of the metallic coil spring 270 is caught and supported by the lower end portion (the moving guide) of the locking bushing 260, and the upper end thereof is supported by an outward flange 243 of the hollow piston shaft 240, at which the locking protrusions 244 are formed.

Referring to FIG. 3, the push head 280 is a part that a user manually pushes to operate. The push head 280 is coupled to the upper end portion of the hollow piston shaft 240, which penetrates the first waterproof wall 212 of the cap 210 and extends upwards, in an interference-fitting manner. The push head 280 has a dispensing port 281 formed in the upper portion thereof, which communicates with the discharge passage 241 in the hollow piston shaft 240. The push head 280 ascends or descends together with the hollow piston shaft 240, and the contents A pumped through the discharge passage 241 are dispensed outside through the dispensing port 281. In addition, the push head 280 has a cylindrical-shaped second waterproof wall 282 formed at the lower portion thereof, which surrounds the outer periphery of the first waterproof wall 212 of the cap 210. Thus, when the push head 280 ascends or descends, as well as when the push head 280 ascends to the maximum extent, the open upper end portion of the first waterproof wall 212 is shielded by the second waterproof wall 282, and the introduction of external foreign substances into the first waterproof wall 212 is therefore prevented.

<Description of Operation and Operational Effects of Waterproof-Type Pump Dispenser According to Present Invention>

Hereinafter, the operation and corresponding operational effects of the waterproof-type pump dispenser according to the present invention, configured as described above, will be described with reference to FIGS. 2 and 6 to 10.

First, in the initial state of the waterproof-type pump dispenser 200, as illustrated in FIG. 2, the push head 280 and the hollow piston shaft 240 are in the state of being located at the most upward position (an upwardly biased state) due to the coil spring 270, and a small amount of suctioned liquid contents is stored in the pressure chamber 221 in the cylinder 220.

In this state, if the push head 280 is pushed down, as illustrated in FIG. 6, the coil spring 270 is compressed, and the hollow piston shaft 240 descends while being guided along the guide grooves 261 in the locking bushing 260. As the hollow piston shaft 240 and the piston 250 descend, the liquid contents A in the pressure chamber 221 move to the discharge passage 241 in the hollow piston shaft 240 through the communication hole 242, and are subsequently dispensed outside through the dispensing port 281 in the push head 280 (refer to the arrow in FIG. 6). As the hollow piston shaft 240 and the piston 250 descend, the internal pressure in the pressure chamber 221 increases, and accordingly, the suction port 222 is maintained in the state of being closed by the check valve 230.

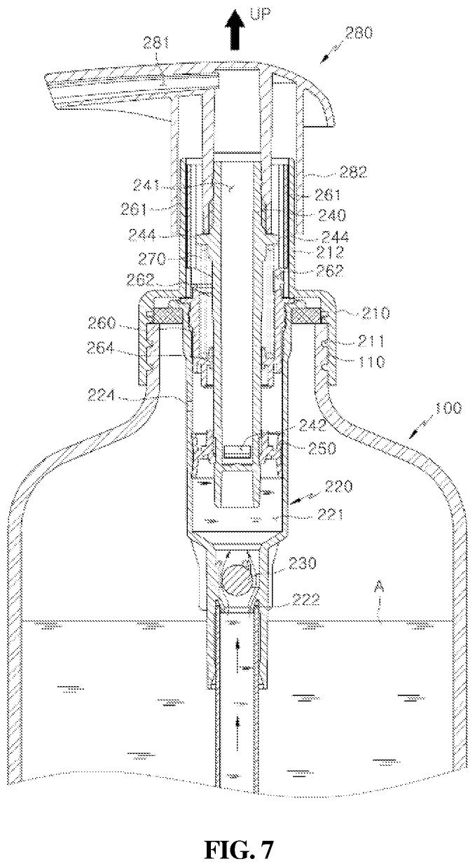

If the push head 280 is released, as illustrated in FIG. 7, the push head 280, the hollow piston shaft 240 and the piston 250 ascend due to the elastic restoring force of the coil spring 270. At this time, the liquid contents A stored in the container 100 open the check valve 230 and move into the pressure chamber 221 in the cylinder 220 (refer to the arrow in FIG. 7). That is, as the hollow piston shaft 240 and the piston 250 gradually ascend due to the restoring force of the coil spring 270, vacuum pressure is applied to the pressure chamber 221 in the cylinder 220. Thus, the check valve 230 slightly moves upwards away from the suction port 222 and opens the same, and the liquid contents A in the container 100 are suctioned into the pressure chamber 221 via the suction tube 223 and the suction port 222. Through the repeated pressing of the push head 280, the liquid contents A stored in the container 100 may be pumped to be used.

During the ascending/descending movement of the push head 280 as well as in the upwardly biased state thereof, since the first waterproof wall 212 of the cap 210 is shielded by the second waterproof wall 282 of the push head 280, it is possible to prevent foreign substances (water) from being introduced into the cylinder 220 from the outside. In addition, since the hollow piston shaft 240 smoothly and accurately ascends or descends along the guide grooves 261 and the moving guide 264 of the locking bushing 260, it is possible to operate the push head 280 with less pressing force.

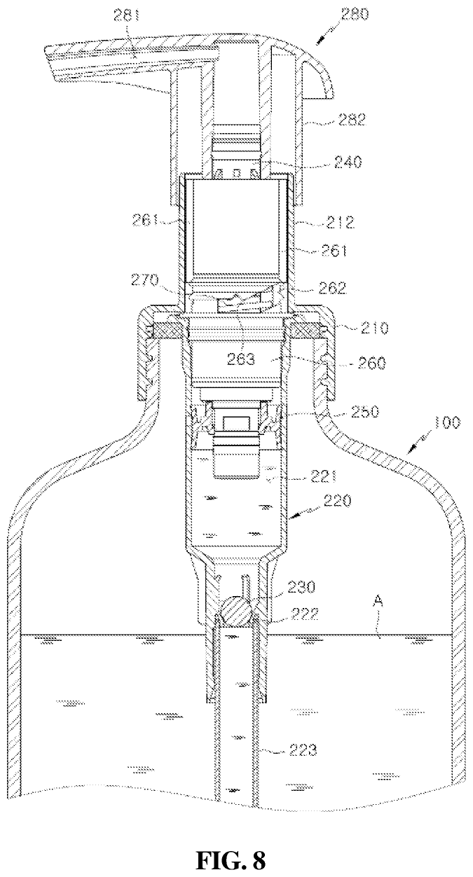

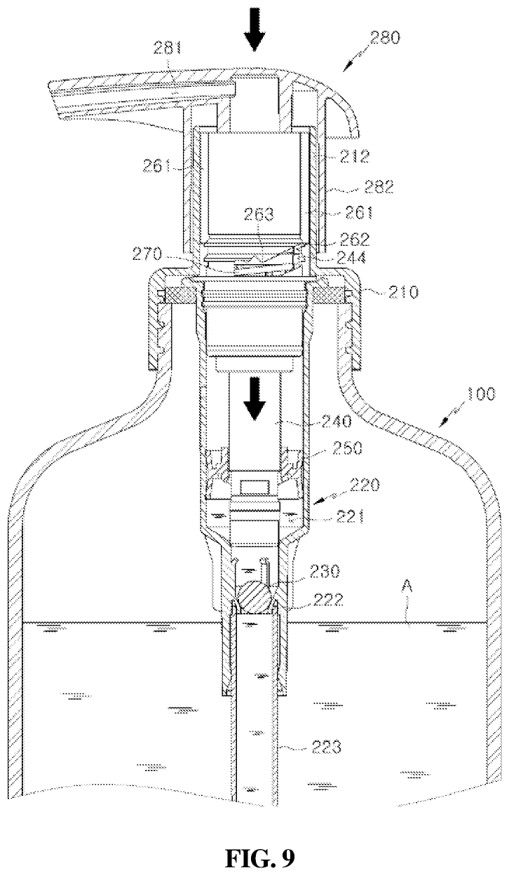

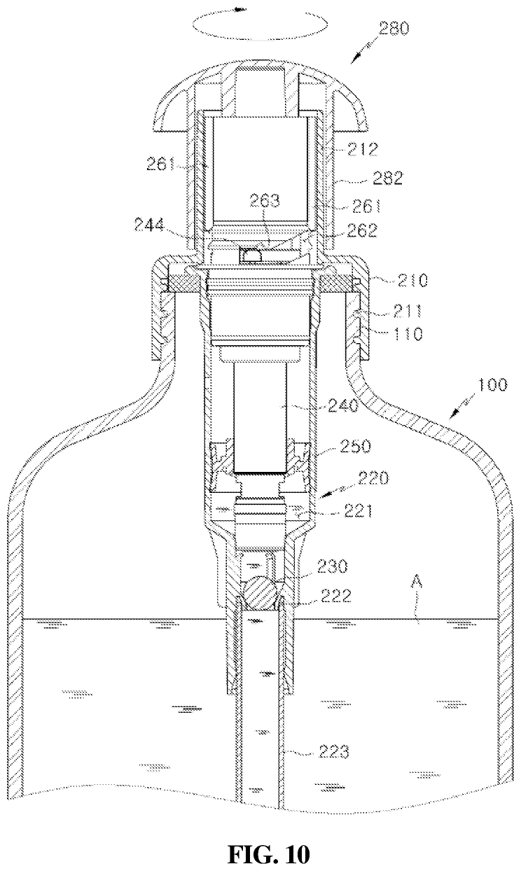

Meanwhile, the hollow piston shaft 240 and the push head 280 are easily locked by pushing down the hollow piston shaft 240 to the maximum extent and rotating the same at a predetermined angle (in the locking direction) via the push head 280. That is, as illustrated in FIGS. 8 and 9, if the hollow piston shaft 240 is moved downwards to the maximum extent (refer to the arrow in FIG. 9), the locking protrusions 244 are located at the lower ends of the guide grooves 261. In this state, as illustrated in FIG. 10, if the hollow piston shaft 240 is rotated at a predetermined angle toward the twist-locking grooves 262 via the push head 280 (refer to the arrow in FIG. 10), the locking protrusions 244 are rotated along the twist-locking grooves 262 and are locked by the same. At this time, the hollow piston shaft 240 is elastically supported in the upward direction by the elastic restoring force of the coil spring 270, and the locking protrusions 244 are caught in the horizontal sections of the twist-locking grooves 262 after passing by the locking bumps 263 in the twist-locking grooves 262. Thus, unless physical force is applied to the hollow piston shaft 240, the hollow piston shaft 240 is maintained in the locked state. In order to release the hollow piston shaft 240 from the locked state, the hollow piston shaft 240 is pushed down to the maximum extent and is rotated in the direction opposite the locking direction via the push head 280 so that the locking protrusions 244 move out of the twist-locking grooves 262 and reach the lower ends of the guide grooves 261. Accordingly, the locking protrusions 244 become movable upwards or downwards.

In conclusion, since the hollow piston shaft 240 is locked using the locking bushing 260, a phenomenon in which the contents A stored in the container 100 leak (a liquid leakage phenomenon) is prevented while the product is distributed in the market or is carried, thereby further improving the reliability of the product. In particular, since the locking bushing 260 is mounted inside the cap 210, the pump dispenser 200 is provided with a locking function without marring the aesthetic appearance of the product. In addition, even when the hollow piston shaft 240 is in a locked state using the locking bushing 260, the first waterproof wall 212 of the cap 210 is completely shielded by the second waterproof wall 282 of the push head 280, thereby fundamentally preventing foreign substances from being introduced into the cylinder 220 from the outside.

### INDUSTRIAL APPLICABILITY

The present invention can be widely used in a waterproof-type pump dispenser field that is capable of dispensing liquid contents stored in a container in a predetermined amount using air pressure.

1. A waterproof-type pump dispenser mounted to a neck 110 of a container 100 and configured to suction and pump liquid contents A to discharge the liquid contents outside, the waterproof-type pump dispenser 200 comprising:
a cap 210 mounted to the neck 110 of the container 100 in a thread-coupling manner, the cap having a cylindrical-shaped first waterproof wall 212 protruding from a center of a top surface thereof;
a cylinder 220 centrally mounted in the cap 210, the cylinder being formed in a shape of a hopper having a pressure chamber 221 formed therein to suction and temporarily store the contents A and a suction port 222 formed in a lower portion thereof and configured to be connected with a suction tube 223 in a fitting manner;
a check valve 230 mounted in the suction port 222 in the cylinder 220 to open or close the suction port 222;
a hollow piston shaft 240 having a lower end portion located in the cylinder 220 so as to be movable upwards or downwards, an upper end portion penetrating the first waterproof wall 212 and extending upwards, a discharge passage 241 formed therein in a longitudinal direction thereof, and locking protrusions 244 protruding from an outer wall of the upper end portion thereof;
a piston 250 coupled to the lower end portion of the hollow piston shaft 240 in a fitting manner so as to ascend or descend together therewith, the piston being configured to open or close a communication hole 242 formed in the lower end portion of the hollow piston shaft 240, and having a periphery closely contacting an inner wall of the cylinder 220;
a cylindrical-shaped locking bushing 260 having a lower end portion coupled to an open upper portion of the cylinder 220 in a fitting manner, an upper end portion accommodated in the first waterproof wall 212 of the cap 210, guide grooves 261 formed in an inner wall of the upper end portion thereof in a longitudinal direction thereof, the guide grooves being arranged opposite each other to receive the locking protrusions 244 therein and to guide ascending/descending movement of the hollow piston shaft 240, and twist-locking grooves 262 extending from lower ends of the guide grooves 261 in a circumferential direction so that, when the hollow piston shaft 240 is pushed down to a maximum extent and is subsequently rotated at a predetermined angle, the locking protrusions 244 are caught in the twist-locking grooves 262 and the hollow piston shaft 240 gets locked;
a coil spring 270 having a lower end caught and supported by the lower end portion of the locking bushing 260 and an upper end supported by the upper end portion of the hollow piston shaft 240, the coil spring being configured to elastically support the hollow piston shaft 240 in an upward direction; and
a push head 280 mounted on the upper end portion of the hollow piston shaft 240 so as to ascend or descend together therewith, the push head having a dispensing port 281 formed in an upper portion thereof so as to communicate with the discharge passage 241 in the hollow piston shaft 240 and a cylindrical-shaped second waterproof wall 282 formed at a lower portion thereof so as to surround an outer periphery of the first waterproof wall 212 of the cap 210.

2. The waterproof-type pump dispenser according to claim 1, wherein the locking bushing 260 has a cylindrical-shaped moving guide 264 integrally formed with an inner wall of the lower end portion thereof, the lower end of the coil spring 270 being caught and supported by the moving guide, and the moving guide having an inner surface contacting an outer wall of the hollow piston shaft 240 to guide ascending/descending movement of the hollow piston shaft 240.
